(19) United States
(12) Patent Application Publication
(10) Pub. No.: US 2026/0195514 A1
(43) Pub. Date: Jul. 9, 2026

(54) SYSTEM AND METHOD FOR PREDICTING POWER CONSUMPTION OF INTEGRATED CIRCUIT AND METHOD FOR DESIGNING INTEGRATED CIRCUIT USING THE SAME

(71) Applicant: SK hynix Inc., Gyeonggi-do (KR)

(72) Inventor: Kyeong Seob KIM, Gyeonggi-do (KR)

(21) Appl. No.: 19/330,751

(22) Filed: Sep. 16, 2025

Related U.S. Application Data
(60) Provisional application No. 63/742,670, filed on Jan. 7, 2025.

(30) Foreign Application Priority Data
Apr. 14, 2025 (KR) 10-2025-0048026

(51) Int. Cl. G06F 30/3312; G06F 30/343; G06F 30/347; G06F 115/06; G06F 119/06

(52) U.S. Cl. CPC G06F 30/3312; G06F 30/343; G06F 30/347; G06F 2115/06; G06F 2119/06

(57) ABSTRACT

A system for predicting power consumption includes a simulator configured to generate vector data by verifying a function of a target circuit implemented with Register-Transfer Level (RTL) design data; and a power prediction circuit configured to predict, before the RTL design data is synthesized into a gate level, power consumption by allowing the target circuit implemented with the RTL design data to process a plurality of requests for a preset prediction time using the vector data as an input vector.

### CROSS-REFERENCES TO RELATED APPLICATION

The present application claims priority under 35 U.S.C. § 119(e) to Korean application number 10-2025-0048026, filed on Apr. 14, 2025, which claims priority to U.S. patent application No. 63/742,670, filed on Jan. 7, 2025, which are incorporated herein by reference in their entirety.

### BACKGROUND

### 1. Technical Field

The embodiments of the present disclosure generally relate to a semiconductor integrated circuit, and more particularly, to a system and method for predicting the power consumption of an integrated circuit and a method for designing the integrated circuit using the system and method.

### 2. Related Art

As the process of manufacturing integrated circuits becomes more miniaturized and the scale of circuits integrated into a single chip increases, the power consumption of integrated circuits is also increasing.

During the verification of a layout design process, which is the completion stage of integrated circuit design, an excessive voltage drop phenomenon in integrated circuits may be detected. In this case, layout modification, circuit revision, redesign or the like may be required, and the time and resources consumed in the design process may act as obstacles to securing product competitiveness.

Therefore, it is necessary to predict power consumption in the early stage of integrated circuit design and respond to the predicted power consumption.

### SUMMARY

A system according to an embodiment of the present disclosure may include a simulator configured to generate vector data by verifying a function of a target circuit implemented with Register-Transfer Level (RTL) design data; and a power prediction circuit configured to predict, before the RTL design data is synthesized into a gate level, power consumption by allowing the target circuit implemented with the RTL design data to process a plurality of requests for a preset prediction time using the vector data as an input vector.

A method for predicting power consumption according to an embodiment of the present disclosure may be an operating method of a system for predicting power consumption of an integrated circuit, and may include generating vector data by verifying a function of a target circuit implemented with Register-Transfer Level (RTL) data; and predicting power consumption by controlling the target circuit implemented with the RTL design data so that, before the RTL design data is synthesized into a gate level, a plurality of requests are processed for a preset prediction time using the vector data as an input vector.

A method for designing an integrated circuit according to an embodiment of the present disclosure may be an operating method of a system for designing an integrated circuit, and may include receiving, by the system, Register-Transfer-Level (RTL) data corresponding to a result of behavioral-level design of the target circuit; generating, by the system, vector data by verifying a function of the target circuit implemented with the RTL design data; when verification of the function succeeds, predicting, by the system, power consumption by controlling the target circuit implemented with the RTL design data so that a plurality of requests are processed for a preset prediction time using the vector data as an input vector; and synthesizing, by the system, the RTL design data, power consumption of which is predicted, into a gate level.

Embodiments of the present disclosure may accurately predict the power consumption of an integrated circuit in the early stage of integrated circuit design. Further, the time and resources required for the design of the integrated circuit may be minimized, and additional design cost may be reduced.

### BRIEF DESCRIPTION OF THE DRAWINGS

FIG. 1 is a configuration diagram of a system for predicting the power consumption of an integrated circuit according to an embodiment of the present disclosure.

FIG. 2 is a configuration diagram of an integrated circuit according to an embodiment of the present disclosure.

FIG. 3 is a configuration diagram of a power prediction circuit according to an embodiment of the present disclosure.

FIG. 4 is a diagram for describing monitoring information for each time window and the concept of power prediction using the monitoring information according to an embodiment of the present disclosure.

FIG. 5 is a flowchart for describing a method for predicting the power consumption of an integrated circuit according to an embodiment of the present disclosure.

FIG. 6 is a diagram for describing a method for designing an integrated circuit according to an embodiment of the present disclosure.

### DETAILED DESCRIPTION

Hereinafter, embodiments of the present disclosure will be described in detail with reference to the attached drawings.

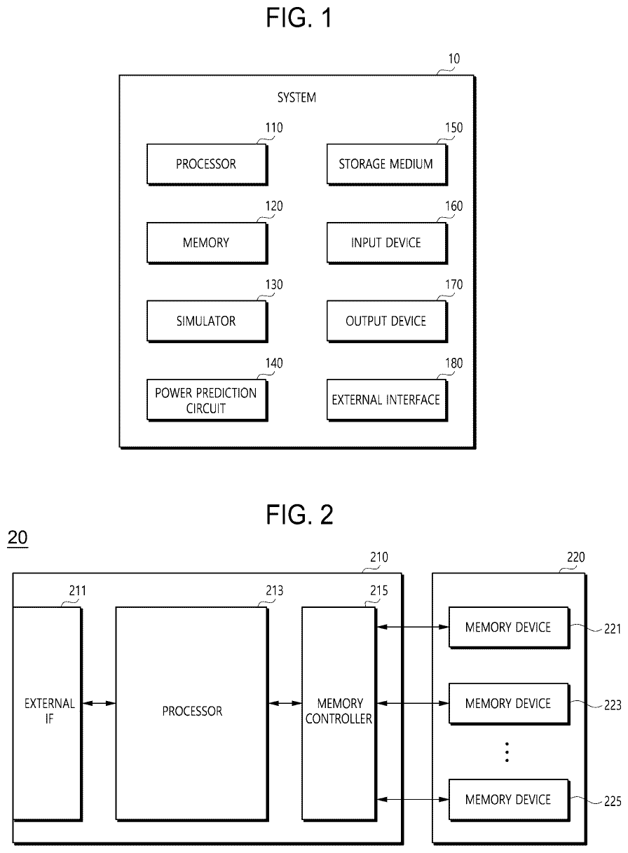

FIG. 1 is a configuration diagram of a system for predicting the power consumption of an integrated circuit, which is a target circuit for a circuit design, according to an embodiment of the present disclosure.

Referring to FIG. 1, a system 10 may include a processor 110, a memory 120, a simulator 130, a power prediction circuit 140, a storage medium 150, an input device 160, an output device 170, and an external interface 180.

Components included in the system 10 may be connected to each other to enable mutual communication through, for example, a bus.

The processor 110 may include at least one core that is capable of executing a certain instruction set. The processor 110 may execute instructions stored in the memory 120, and may perform at least some functions for power consumption prediction according to an embodiment of the present disclosure by executing a program stored in the memory 120.

The memory 120 may be the working memory of the system 10. The memory 120 may store a program to be executed on the system 10, Register-Transfer Level (RTL) design data for a target circuit, reference input data required to simulate the RTL design data, and vector data obtained as the result of the simulation.

The program, the RTL design data, the reference input data, and the vector data may be stored in the storage medium 150, and at least part of the program, the RTL design data, the reference input data, and the vector data, stored in the storage medium 150, may be loaded into the memory 120.

The memory 120 may include a volatile memory such as a Static Random Access Memory (SRAM) or a Dynamic Random Access Memory (DRAM), and may include a nonvolatile memory such as a flash memory.

In an embodiment, the processor 110 may perform at least a portion of designing the target circuit or power consumption prediction by executing at least one instruction included in the program stored in the storage medium 150 and the memory 120.

The simulator 130 may be provided with the RTL design data and the reference input data, and may generate vector data indicating time-dependent values of input signals, internal signals, and output signals of RTL design data for the target circuit, by simulating the operation of the target circuit defined by the RTL design data based on the reference input data. In an embodiment, the vector data may be at least one of a Value Change Dump (VCD) format or a Fast Signal DataBase (FSDB).

The power prediction circuit 140 may predict the power consumption of the target circuit using the vector data generated by the simulator 130 as an input vector.

The power prediction circuit 140 may receive the RTL design data of the target circuit and the input vector, and then run the target circuit, which is represented at a logic level corresponding to the RTL design data, depending on the input vector for a preset operation time. The power prediction circuit 140 may divide the operation time of the RTL design data depending on the input vector into a preset number of time windows and may then predict power consumption for each of the time windows. The power prediction circuit 140 may predict the maximum power section based on the power consumption predicted for each time window.

The storage medium 150 may be configured not to lose the stored data even when power supplied to the system 10 is interrupted. In an embodiment, the storage medium 150 may include a nonvolatile memory, such as an Electrically Erasable Programmable Read-Only Memory (EEPROM), a flash memory, a Phase-change Random Access Memory (PRAM), a Resistance Random Access Memory (RRAM), a Nano Floating Gate Memory (NFGM), a Polymer Random Access Memory (PORAM), a Magnetic Random Access Memory (MRAM), and a Ferroelectric Random Access Memory (FRAM). The storage medium 150 may be detachably connected to the system 10.

The storage medium 150 may store data to be processed by the processor 110 and/or data processed by the processor 110. The storage medium 150 may store the program, the RTL design data, the reference input signal, and the vector data, and may also store data generated during the operation of the system 10.

The input device 160 may include a keyboard, a pointing device, or the like, and the output device 170 may include a display device, a printer, a speaker, or the like. Through the input device 160, the operator of the system 10 may trigger the execution of the program by the processor 110, may input data required for the operation of the system 10, or may input conditions or data required to design the target circuit or to predict power consumption.

Through the output device 170, the system 10 may output signals, which are generated during the design or the prediction of power consumption for the target circuit.

The external interface 180 may provide access to a network outside the system 10. For example, the network may include a plurality of computing systems and communication links, and the communication links may include wired links, optical links, wireless links or other types of links.

FIG. 2 is a configuration diagram of an integrated circuit as a target circuit for a circuit design according to an embodiment of the present disclosure.

An integrated circuit 20 may include a controller 210 and a memory resource 220.

The controller 210 may perform operations based on data transmitted from an external device (not illustrated) or data read from the memory resource 220 in response to an instruction from the external device, and may store data accompanying the operations in the memory resource 220. The memory resource 220 may include a plurality of memory devices 221, 223, and 225.

The controller 210 may include an external interface 211, a processor 213, and a memory controller 215.

The controller 210 may be connected to the external device through the external interface 211 and may then receive a request from the external device. The controller 210 may process the request of the external device under the control of the processor 213, and may control the memory resource 220 for such request processing.

The external interface 211 may relay communication between the external device and the integrated circuit 20 based on an established interface protocol. In an embodiment, the external interface 211 may support a plurality of sub-protocols defined in a Compute Express Link (CXL) protocol, and may transmit and receive messages and/or data between the external device and the integrated circuit 20 through the plurality of sub-protocols. The sub-protocols of the CXL protocol may include, for example, a non-coherent protocol (or an I/O protocol: IO)(CXL.io), a coherent protocol (or a cache protocol; CACHE) (CXL.cache), and a memory access protocol (or a memory protocol: MEM)(CXL.mem).

The processor 213 may include an accelerator that provides functions useful for the external device. For example, the processor 213 may include at least one of a programmable component such as a graphic processing unit (GPU) or a neural processing unit (NPU), a component that provides a fixed function such as an intellectual property (IP) core, and a reconfigurable component such as a field programmable gate array (FPGA).

The memory controller 215 may communicate with memory resource 220 based on a protocol that is independent of or dependent on the external interface 211. The memory controller 215 may access the memory resource 220 to read or write data under the control of the processor 213. The memory controller 215 may provide access to the memory resource 220 by the external device through the external interface 211 as well as access to the memory resource 220. In some embodiments, the memory resource 220 may correspond to a memory attached to a device with a CXL specification.

In an embodiment, the integrated circuit 20 may be a CXL memory device but is not limited thereto.

The system 10 may predict power consumption and the maximum power section by operating the RTL design data for a preset operation time depending on the input vector, generated by simulating the RTL design data for the integrated circuit 20 as the CXL memory device.

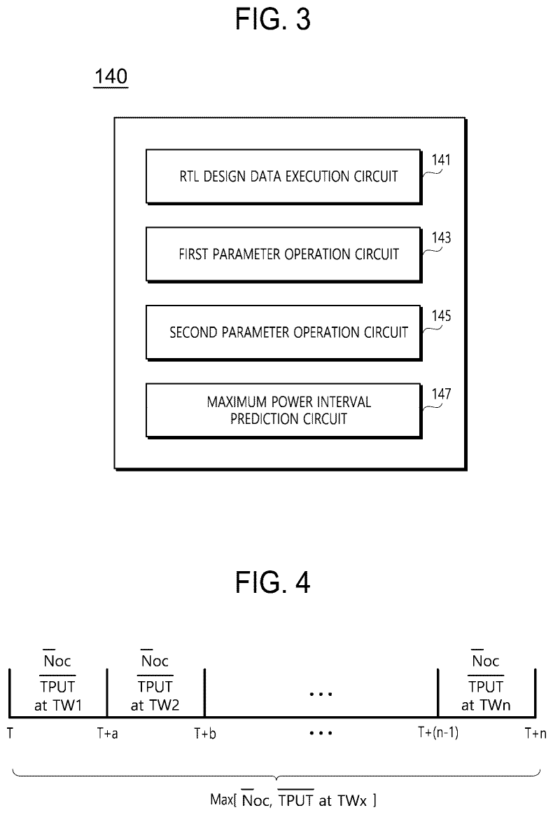

FIG. 3 is a configuration diagram of the power prediction circuit 140 according to an embodiment of the present disclosure.

Referring to FIG. 3, the power prediction circuit 140 may include an RTL design data execution circuit 141, a first parameter operation circuit 143, a second parameter operation circuit 145, and a maximum power section prediction circuit 147.

The RTL design data execution circuit 141 may provide the integrated circuit 20, which is represented by the RTL design data, with the request of an external device, and may process the RTL design data, i.e., may run the integrated circuit 20 for a preset time, for example, a prediction time, depending on an input vector. The input vector may include signal information required for the integrated circuit 20 to process the request of the external device. Here, the external device may be virtual for the integrated circuit 20 and therefore the request of the external device may be predetermined.

The first parameter operation circuit 143 may divide the prediction time into a preset number of time windows, and may then calculate the number of average outstanding requests, that is, an average outstanding count, for each of the time windows.

The outstanding count OSC may be the number of requests for which response signals are not transmitted from the integrated circuit 20 to the external device among requests provided from the external device to the integrated circuit 20. That is, the outstanding count OSC may be the number of requests, the processing of which has not yet been completed by the integrated circuit 20.

In an embodiment, the average outstanding count N̅_{oc} may be calculated based on the following [Equation 1].

$${\overline{N}}_{OC} = \frac{1}{et - st} {\int }_{st}^{et} {N}_{Outstanding\_Count} ( t ) dt \qquad [ Equation 1 ]$$

In [Equation 1], “st” may be the start time of each time window, “et” may be the end time of the time window, and “N_{Outstanding_Count}(t)” may be an outstanding count in time window t.

The second parameter operation circuit 145 may calculate average throughput for each time window.

In an embodiment, the average throughput T̅P̅U̅T̅ may be calculated based on the following [Equation 2].

$$TPUT = \frac{1}{et - st} {\int }_{st}^{et} {Len}_{Packet} * {N}_{Request\_Count} ( t ) dt \qquad [ Equation 2 ]$$

In [Equation 2], “st” may be the start time of each time window, “et” may be the end time of the time window, and “Len_{Packet}*N_{Request_Count}(t)” may be the number of requests having a specific length at time window t.

The maximum power section prediction circuit 147 may predict the maximum power section corresponding to the respective maximum values of the average outstanding count N̅_{OC} and the average throughput T̅P̅U̅T̅ among the average outstanding counts N̅_{OC} and the average throughputs T̅P̅U̅T̅ of the individual time windows within the prediction time.

The time window corresponding to the maximum value of the average outstanding count N̅_{OC} may be different from the time window corresponding to the maximum value of the average throughput TPUT. In this case, both the time window corresponding to the maximum value of the average outstanding count N̅_{OC} and the time window corresponding to the maximum value of the average throughput TPUT may be regarded as the maximum power sections.

FIG. 4 is a diagram for describing monitoring information for each time window and the concept of power prediction using the monitoring information according to an embodiment of the present disclosure.

Referring to FIG. 4, the power prediction circuit 140 may control the integrated circuit 20 implemented with RTL design data to execute the request of an external device depending on an input vector during a power consumption prediction section T to T+n.

The power prediction circuit 140 may divide the power consumption prediction section T to T+n into a plurality of time windows T to T+a, T+a to T+b, . . . , T+(n−2) (not shown) to T+(n−1), and T+(n−1) to T+n.

The power prediction circuit 140 may calculate the average outstanding count N̅_{OC} and the average throughput TPUT for each of time windows TW1(T to T+a), TW2(T+a to T+b), . . . , TWn(T+(n−1) to T+n)).

The power prediction circuit 140 may predict at least one time window TWx having the maximum value between the average outstanding count N̅_{OC} and the average throughput TPUT to be a section having the maximum power consumption, that is, the maximum power section.

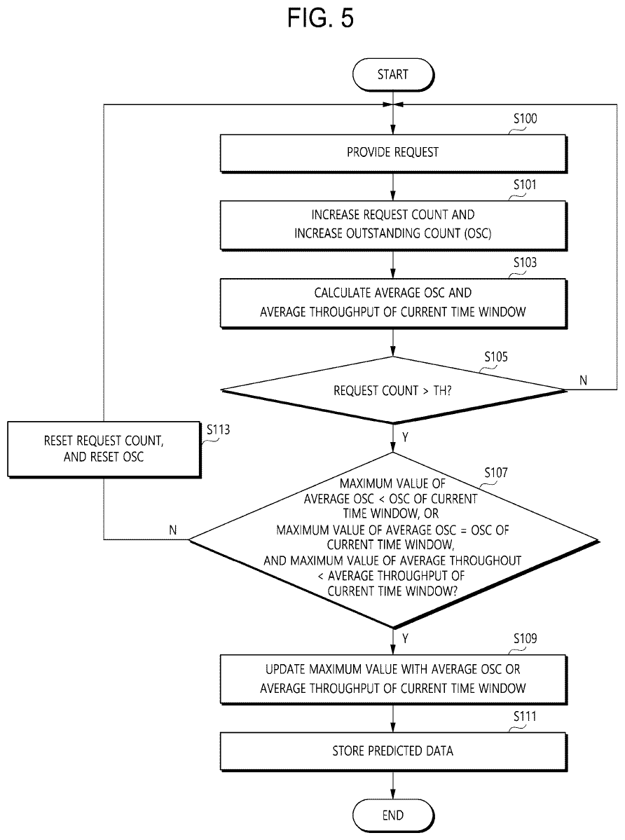

FIG. 5 is a flowchart for describing a method for predicting the power consumption of the integrated circuit 20 according to an embodiment of the present disclosure.

FIG. 5 may illustrate a method for predicting power consumption in a unit time window of a prediction section.

A system 10 that predicts power consumption may predict power consumption while providing a request to the integrated circuit 20 implemented with RTL design data for a preset prediction time depending on an input vector obtained as the result of simulation of the RTL design data.

Referring to FIG. 5, the system 10 may provide a request to the integrated circuit 20 in operation S100, and may increase a request count and an outstanding count OSC in operation S101.

The system 10 may calculate an average outstanding count OSC and average throughput in a current time window in operation S103.

The system 10 may determine whether the request count exceeds a threshold TH in operation S105. When the request count does not exceed the threshold TH (in the case of No in operation S105), the system 10 may provide a request to the integrated circuit 20 in operation S100.

When the request count exceeds the threshold TH (in the case of Yes in operation S105), the system 10 may determine whether the average outstanding count OSC of the current time window is greater than the maximum value of the average outstanding count OSC calculated in at least one previous time window. Alternatively, in operation S107, the system 10 may determine whether the maximum value of the average outstanding count OSC of at least one previous time window is equal to the average outstanding count OSC of the current time window, and may determine whether the average throughput of the current time window is greater than the maximum value of the average throughput of at least one previous time window.

When the average outstanding count OSC of the current time window is greater than the maximum value of the average outstanding count OSC calculated in the at least one previous time window or when the maximum value of the average outstanding count OSC calculated in the at least one previous time window is equal to the average outstanding count OSC of the current time window and the average throughput of the current time window is greater than the maximum value of the average throughput calculated in the at least one previous time window (in the case of Yes in operation S107), the system 10 may update the maximum value with the average outstanding count OSC or the average throughput of the current time window in operation S109, and may store the updated maximum value as the predicted data in operation S111.

When the average outstanding count OSC of the current time window is less than the maximum value of the average outstanding count OSC calculated in the at least one previous time window or when the maximum value of the average outstanding count OSC calculated in the at least one previous time window is equal to the average outstanding count OSC of the current time window and the average throughput of the current time window is less than the maximum value of the average throughput calculated in the at least one previous time window (in the case of No in operation S107), the system 10 may reset the request count and the outstanding count OSC in operation S113, and may predict power consumption in the next time window.

The predicted maximum power section may be stored in the controller of the integrated circuit 20, the design of which has been physically completed, and may then be utilized in Quality of Service (QoS) policies such as throttling of the integrated circuit 20.

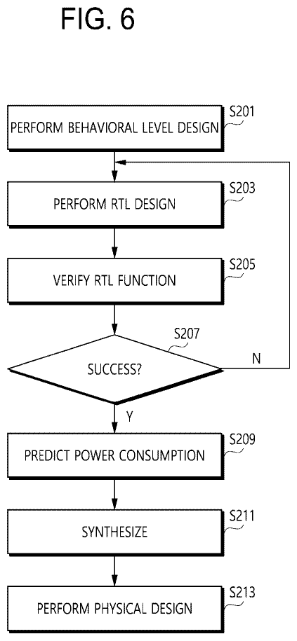

FIG. 6 is a diagram for describing a method for designing the integrated circuit 20 according to an embodiment of the present disclosure.

Referring to FIG. 6, for example, behavioral-level design configured to design the function of the integrated circuit 20 desired to be designed through the system 10 may be performed in operation S201. Behavioral-level design may be a process of allowing a target circuit to operate in accordance with a scheduled algorithm.

When the function design is completed, RTL design may be performed through the system 10 in operation S203. That is, the integrated circuit 20 may be designed at a logic level through the RTL. Through the RTL design, the integrated circuit 20 may be represented by the RTL design data. The RTL design may be a process of allowing data delivery between the designed registers and the integrated circuit 20 represented by the RTL design data to be accurately performed.

In an embodiment, the RTL design may be a programming process using Hardware Description Language (HDL). As examples of HDL, there may be Verilog and VHSIC Hardware Description Language (VHDL).

After the RTL design, the system 10 may perform function verification on RTL design data in operation S205. Function verification may be a process of generating vector data indicating time-dependent values of the input signal, internal signal, and output signals of the integrated circuit 20 by simulating the operation of the integrated circuit 20 defined by the RTL design data depending on reference input data.

When the RTL design data is not successfully operated (in the case of N in operation S207), RTL design may be re-performed through the system 10 in operation S203.

When the RTL design data is successfully operated (in the case of Yes in operation S207), the system 10 may predict the power consumption of the target circuit using the vector data, generated as the result of function verification, as an input vector, in operation S209.

The process of predicting power consumption may include a process of dividing a power consumption prediction section into a plurality of time windows, calculating an average outstanding count and average throughput in each time window, and predicting a time window corresponding to the maximum value of the average outstanding count and/or the maximum value of the average throughput to be the maximum power section, as described above with reference to FIGS. 3 to 5.

The system 10 may synthesize the RTL design data by converting the RTL design data into a gate-level netlist based on design conditions and a library in operation S211. The design conditions may include conditions related to area, speed, power, and the like. The library may include information such as standard cells, a memory, and functional circuits (IP).

The system 10 may physically design the integrated circuit 20 based on the result of synthesis in operation S213.

When the RTL design data as a result of operation S203 functions successfully, the maximum power section may be predicted, and thus whether a power condition required in the synthesis process in operation S209 is satisfied may be determined in advance.

Therefore, when the power condition is not satisfied, the integrated circuit may be immediately revised at RTL level, and thus the time and resources consumed in the design of the integrated circuit may be reduced.

As described above, those skilled in the art to which the present disclosure pertains will understand that the embodiments of the present disclosure may be implemented in other specific forms without departing from the spirit or essential features of the disclosure. Accordingly, it should be understood that the above-described embodiments are illustrative rather than restrictive from all aspects. It should be understood that the embodiments of the present disclosure are defined by the accompanying claims rather than the detailed description, and all changes or modifications derived from the meaning and scope of the claims and equivalents thereof are included in the scope of the present disclosure. Furthermore, the embodiments may be combined to form additional embodiments.

What is claimed is:

1. A system comprising:
a simulator configured to generate vector data by verifying a function of a target circuit implemented with Register-Transfer Level (RTL) design data; and
a power prediction circuit configured to predict, before the RTL design data is synthesized into a gate level, power consumption by allowing the target circuit implemented with the RTL design data to process a plurality of requests for a preset prediction time using the vector data as an input vector.

2. The system according to claim 1, wherein the power prediction circuit is configured to divide the prediction time into a preset number of time windows and predict power consumption for each of the time windows.

3. The system according to claim 1, wherein the power prediction circuit is configured to divide the prediction time into a preset number of time windows and calculate an average outstanding count and average throughput for each of the time windows.

4. The system according to claim 1, wherein the power prediction circuit is configured to:
divide the prediction time into a preset number of time windows and calculate an average outstanding count and average throughput for each of the time windows, and
predict, as a maximum power consumption section, a time window corresponding to a maximum value of the average outstanding count or a time window corresponding to a maximum value of the average throughput, or a combination thereof.

5. The system according to claim 1, wherein the target circuit comprises a Compute Express Link (CXL) memory device.

6. An operating method of a system for predicting power consumption of a target circuit, the operating method comprising:
generating vector data by verifying a function of a target circuit implemented with Register-Transfer Level (RTL) data; and
predicting power consumption by controlling the target circuit implemented with the RTL design data so that, before the RTL design data is synthesized into a gate level, a plurality of requests are processed for a preset prediction time using the vector data as an input vector.

7. The operating method according to claim 6, wherein the predicting of the power consumption comprises:
dividing the prediction time into a preset number of time windows and predicting power consumption for each of the time windows.

8. The operating method according to claim 6, wherein the predicting of the power consumption comprises:
dividing the prediction time into a preset number of time windows and calculating an average outstanding count and average throughput for each of the time windows.

9. The operating method according to claim 6, wherein predicting the power consumption comprises:
dividing the prediction time into a preset number of time windows and calculating an average outstanding count and average throughput for each of the time windows; and
predicting, as a maximum power consumption section, a time window corresponding to a maximum value of the average outstanding count or a time window corresponding to a maximum value of the average throughput, or a combination thereof.

10. An operating method of a system for designing a target circuit, the operating method comprising:
receiving, by the system, Register-Transfer-Level (RTL) data corresponding to a result of behavioral-level design of the target circuit;
generating, by the system, vector data by verifying a function of the target circuit implemented with the RTL design data;
when verification of the function succeeds, predicting, by the system, power consumption by controlling the target circuit implemented with the RTL design data so that a plurality of requests are processed for a preset prediction time using the vector data as an input vector; and
synthesizing, by the system, the RTL design data, power consumption of which is predicted, into a gate level.

11. The operating method according to claim 10, wherein predicting the power consumption comprises:
dividing the prediction time into a preset number of time windows and predicting power consumption for each of the time windows.

12. The operating method according to claim 10, wherein predicting the power consumption comprises:
dividing the prediction time into a preset number of time windows and calculating an average outstanding count and average throughput for each of the time windows.

13. The operating method according to claim 10, wherein predicting the power consumption comprises:
dividing the prediction time into a preset number of time windows and calculating an average outstanding count and average throughput for each of the time windows; and
predicting, as a maximum power consumption section, a time window corresponding to a maximum value of the average outstanding count or a time window corresponding to a maximum value of the average throughput, or a combination thereof.
